(19) United States
(12) Patent Application Publication
(10) Pub. No.: US 2009/0222274 A1
(43) Pub. Date: Sep. 3, 2009

(54) PREVENTING FRAUD IN A VIRTUAL UNIVERSE

(76) Inventors: Rick A. Hamilton,, II, Charlottesville, VA (US); Brian M. O'Connell, Cary, NC (US); Clifford A. Pickover, Yorktown Heights, NY (US); Keith R. Walker, Austin, TX (US)

Correspondence Address: HOFFMAN WARNICK LLC, 75 STATE ST, 14TH FLOOR, ALBANY, NY, 12207, US

(21) Appl. No.: 12/039,215

(22) Filed: Feb. 28, 2008

(51) Int. Cl. G06Q 99/00

(52) U.S. Cl. 705/1

(57) ABSTRACT

A solution for preventing frauds in a virtual universe is disclosed. A user interface may be deployed to a user of the virtual universe which enables the user to report a fraudulent activity of a virtual entity. Such a report is processed by an administration center, and the fraudulent virtual entity may be publically tagged such that further frauds can be prevented.

### TECHNICAL FIELD OF THE INVENTION

This invention relates generally to virtual universes, and more specifically to preventing fraudulent phishing activity in a virtual universe.

### BACKGROUND OF THE INVENTION

Virtual universes or virtual worlds are computer-based simulated environments intended for its users to inhabit and interact via avatars, which are graphical representations that others can see. An avatar often takes the form of a cartoon-like human character. An agent is a user's account with a virtual universe, upon which the user can build an avatar. The agent is tied to the inventory of assets the user owns. These types of virtual universes are now common in massive multiplayer online games, such as Second Life (Second Life is a trademark of Linden Research in the United States, other countries, or both). Avatars in the virtual universes can do a wide range of business and/or social activities. Virtual universes may include other virtual entities such as a virtual store, a virtual club, an article, etc. Each virtual entity including an avatar is assigned with a universally unique identification (UUID) in the virtual universe.

A variety of fraudulent behaviors may be conducted in virtual universes. For example, phishing refers to a form of fraud in which an entity, such as a website or a virtual store, masquerades as another entity by, e.g., copying the other entity's appearance and/or other characteristics. The goal of the fraudulent emulation is to, e.g., lure visitors into providing personal or financial information, which the fraudulent/phishing entity may use for monetary gains. Presently, no adequate solution exists to prevent or reduce phishing in a virtual universe.

### SUMMARY OF THE INVENTION

In one embodiment, there is a method for tagging a virtual entity in a virtual universe. In this embodiment, the method comprises: providing a mechanism for a user of the virtual universe to report a conduct of the virtual entity; receiving the report from the user; and tagging the virtual entity based on the report in a public manner in the virtual universe.

In a second embodiment, there is a system for tagging a virtual entity in a virtual universe. In this embodiment, the system comprises: system for providing a mechanism for a user of the virtual universe to report a conduct of the virtual entity; system for receiving the report from the user; and system for tagging the virtual entity based on the report in a public manner in the virtual universe.

In a third embodiment, there is a computer program product embodied in a computer readable medium. In this embodiment, this program product comprises: computer usable program code which, when executed by a computer system, enables the computer system to: provide a mechanism for a user of the virtual universe to report a conduct of the virtual entity; receive the report from the user; and tag the virtual entity based on the report in a public manner in the virtual universe.

In a fourth embodiment, there is a method for providing a system for tagging a virtual entity in a virtual universe. In this embodiment, the method comprises at least one of: creating, maintaining, deploying or supporting a computer infrastructure being operable to: provide a mechanism for a user of the virtual universe to report a conduct of the virtual entity; receive the report from the user; and tag the virtual entity based on the report in a public manner in the virtual universe.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE DRAWINGS

FIG. 1 shows a system according to one embodiment of this invention;

FIG. 2 shows embodiments of an operation of a fraudulence preventing system according to the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

### 1. System Overview

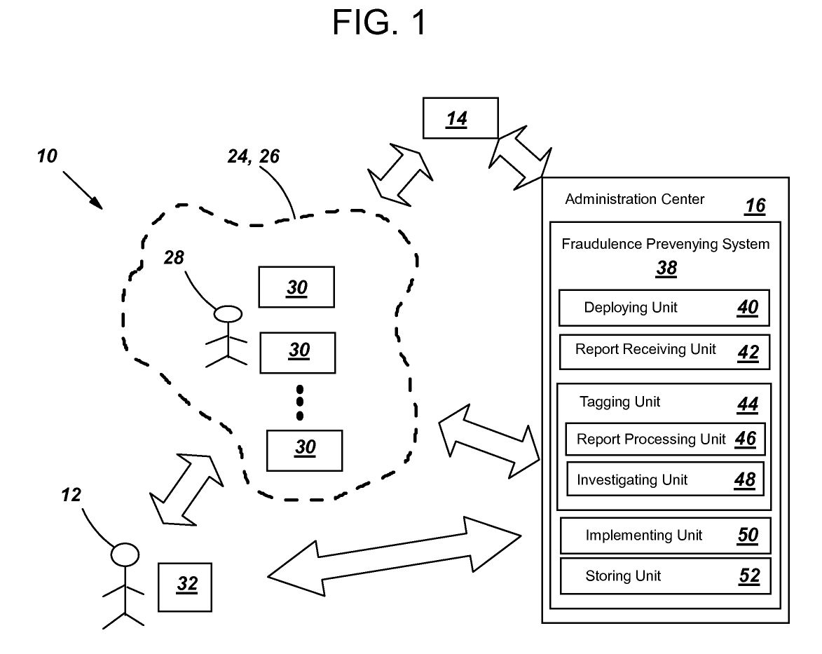

FIG. 1 shows a block diagram of a system 10 according to an embodiment. System 10 includes a virtual world user(s) 12, a virtual world server(s) 14 and an administration center 16. Virtual world server 14 supports a virtual universe 24 including at least one virtual region 26 (shown together with virtual universe 24) where virtual world user 12 may conduct activities via a virtual world representation 28 usually referred to as an avatar 28. Virtual universe 24 may also include various other virtual entities 30, such as a virtual store. In this description, other virtual entities 30 and avatar 28 may be generally referred to as a virtual entity 28/30, unless specifically indicated otherwise. To this extent, in the current description, virtual entity 28/30 refers to any virtual representation in virtual universe 24 including, for example, avatar 28, virtual region 26 and/or a virtual place, e.g., a virtual store, within virtual region 26, an article in virtual region 26, such as a car of avatar 28, etc. In operation, user 12 attends virtual universe 24 through a virtual world client/agent 32, e.g., a virtual world account established through, e.g., a personal computer, communicatively coupled to virtual world server 14. Virtual entities 28/30 interact with one another in the virtual activities.

Administration center 16 includes a fraudulence preventing system 38. Fraudulence preventing system 38 includes a deploying unit 40; a report receiving unit 42; a tagging unit 44 including a report processing unit 46 and an investigating unit 48; an implementing unit 50; and a storing unit 52. Other component(s) required for the operation of fraudulence preventing system 38 may also be included as is understood in the art.

According to an embodiment, administration center 16 may be implemented by a computer system. The computer system can comprise any general purpose computing article of manufacture capable of executing computer program code installed thereon to perform the process described herein. The computer system can also comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

As should be appreciated, virtual world server 14 and administration center 16 and components thereof may be positioned at the same physical location or may be at different physical locations. The interaction of system 10 components will be described herein in detail.

### 2. Operation Methodology

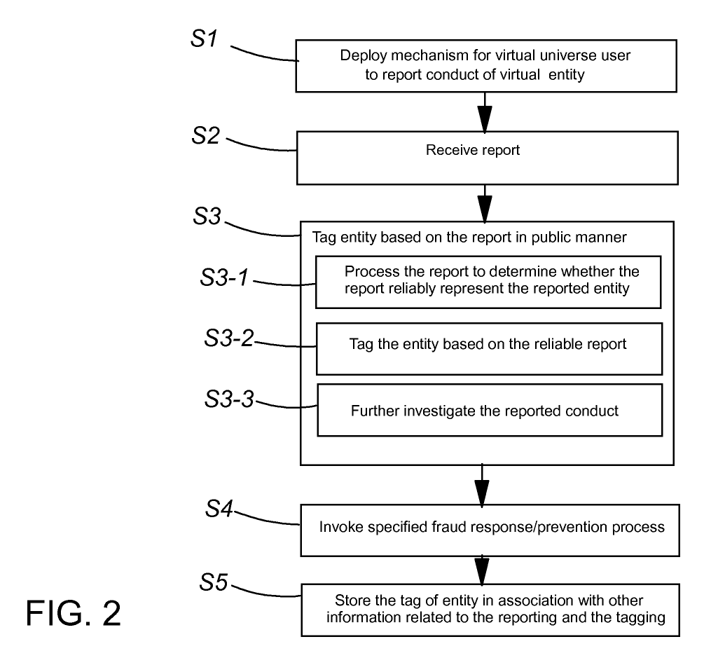

An embodiment of the operation of fraudulence preventing system 38 is shown in the flow diagram of FIG. 2. Referring to FIGS. 1-2, collectively, in process S1, deploying unit 40 may deploy/provide a mechanism for user 12 of virtual universe 24 to report a conduct of an entity 28/30. Any solution may be used to enable the reporting. For example, deploying unit 40 may change the user interface of virtual world client/agent 32 of user 12 to include a command to implement the reporting. Typically, users 12 of virtual universe 24 are able to select an entity 28/30 within virtual universe 24 for an action, which is commonly achieved through an input device such as a mouse and/or a keyboard. An input combination may display to user 12 a “context” menu for a selected entity 28/30, which may display candidate/appropriate action(s) to be performed with respect to the selected entity 28/30. According to an embodiment, deploying unit 40 may modify the “context” menu to add an action to report a conduct of the selected entity 28/30. The enabled reporting may be implemented in various manners. For example, a report may describe the conduct or may summarily tag entity 28/30 based on the conduct.

In process S2, report receiving unit 42 receives a report from a user 12 regarding an entity 28/30. According to an embodiment, report receiving unit 42 may filter the reports to allow only reports of interest to be further processed. For example, a report of a fraudulent/phishing conduct of an entity 28/30 may be of interest. As described herein, the report may describe the phishing conduct in detail or may just label/tag the entity 28/30 as committing a phishing conduct(s). The phishing entity 28/30 may either be avatar 28 or other entities 30. For example, a report may indicate that an avatar 28 fraudulently emulates another avatar 28. For another example, a report may indicate a virtual store 30 fraudulently emulates the appearance of another virtual store 30 doing business in virtual universe 24, or fraudulently emulates a store doing business outside virtual universe 24 by presenting an unauthorized virtual representation of the outside store in virtual universe 24.

According to an embodiment, report receiving unit 42 may associate the UUID of the entity 28/30 being reported with other information related to the report. For example, the UUID of the virtual entity 28/30 may be associated with the reported conduct, the UUID of the user 12 who makes the report, the date and time of the report, the location coordinate(s) (virtual location) of the reporting user 12 at the time of the report, UUID or user ID of other avatar 28 or user 12 within a specified radius of the reported virtual entity 28/30, etc.

In process S3, tagging unit 44 tags the entity 28/30 based on the report in a public manner in virtual universe 24/virtual region 26. The tagging is public such that, for example in the case that a phishing conduct is reported, other user 12 may become aware of the phishing characteristic of the tagged entity 28/30. The public tagging may be implemented by any solution. For example, when an entity 28/30 is tagged as committing a phishing conduct(s), an audio and/or visual alert may be attached to the entity 28/30 such that other user 12 may clearly notice that. In addition, the UUID of the tagged entity 28/30 may be associated with the tag in any manner.

Process S3 may include multiple sub-processes. In sub-process S3-1, report processing unit 46 may process the report(s) to determine whether the report reliably represents the reported entity 28/30. A report may be unreliable for various reasons. For example, a competitor may tend to forge bad reports against a virtual store 30 with malicious intent. An avatar 28 may over report a single bad experience with a virtual store 30 by repeatedly reporting the bad experience. Report processing unit 46 may use any standard in determining an unreliable report(s). For example, report processing unit 46 may delete: duplicate reports by the same user 12 regarding the same issue; reports by those known to be in competition with the reported entity 28/30; reports by a user 12 who has been tagged as fraudulent; or reports older than a specific time limit. In addition, report processing unit 46 may also set some threshold, e.g., empirical threshold, in determining whether a report reliably represent the entity 28/30, i.e., whether the threshold is satisfied. For example, the threshold may be: the number of users 12 reporting the same kind of conduct of an entity 28/30, e.g., phishing; the percentage of users 12 within a certain radius of the entity 28/30 who report phishing conduct(s) of the entity 28/30; percentage of users 12 who had transactions with the entity 28/30 and later reported phishing conducts, etc. Moreover, report processing unit 46 may assign certificate/privilege to some virtual entity 28/30 to circumvent the normal standards. For example, a virtual store 30 may be certified as reliable and all phishing reports regarding the virtual store 30 will be deleted as unreliable. For another example, an avatar 28, e.g., a virtual police officer, may be certified as reliable and reports from the avatar 28 are deemed reliable without meeting the threshold(s).

In sub-process S3-2, in the case that a report is determined as reliable, tagging unit 44 may tag the respective virtual entity 28/30 based on the reliable report. For example, tagging unit 44 may further determine whether the report meets predetermined criteria, e.g., set for a specific type of conduct (fraudulence conduct). In response to the report meeting the criteria, tagging unit 44 may retrieve/determine a rule(s) associated with the criteria. The rule may stipulate how the entity 28/30 will be tagged and what further fraudulence prevention actions may be performed on the entity 28/30. The retrieved rule(s) may be applied to tag the virtual entity.

In sub-process S3-3, investigating unit 48, in addition to the public tagging, may also further investigate the reported conduct, e.g., a phishing conduct, by communicating separately to at least one of the reporting user 12, another user 12 (other than the reporting user 12), the tagged entity 28/30, or an administrator of virtual universe 24. For example a message may be sent to those entities separately to notify the tagging of the virtual entity 28/30 as, e.g., fraudulent (phishing), and may further investigate the reporting and/or the tagging before those entities. For example, the reporting user 12 may be inquired regarding the reported conduct; the tagged entity 28/30 may be given an opportunity to argue against the tagging; other user 12 may either support or raise questions regarding the tagging/reporting; and the administrator may provide further information regarding, e.g., how the reported virtual entity 28/30 is established and operated in virtual universe 24.

In process S4, implementing unit 50 may invoke specified fraud response/prevention process(es) in the case that a virtual entity 28/30 is tagged as fraudulent/phishing. Any response may be implemented. For example, the account of the fraudulent/phishing entity 28/30 may be suspended. For another example, virtual universe features available to the entity 28/30 may be revoked or reduced, such as revoking rights to engage in transactions, to chat, to move beyond specific boundary coordinates, etc.

In process S5, storing unit 52 may store the tag of a virtual entity 28/30 in association with other information related to the reporting and the tagging. For example, the tag will be associated with the UUID of the virtual entity 28/30. The other associated information may include the UUID of the one that reports the conduct, the date and time of the report, the location coordinate(s) (virtual location) of the user 12/avatar 28 at the time of the report, UUID or user ID of other avatars 26 or users 12 within a specified radius of the tagged virtual entity 28/30, etc.

### 3. Conclusion

While shown and described herein as a method and system for tagging a virtual entity in a virtual universe, it is understood that the invention further provides various alternative embodiments. For example, in an embodiment, the invention provides a program product stored on a computer-readable medium, which when executed, enables a computer infrastructure to tag an entity in a virtual universe. To this extent, the computer-readable medium includes program code, such as fraudulence preventing system 38 (FIG. 1), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, and/or as a data signal traveling over a network (e.g., during a wired/wireless electronic distribution of the program product).

In another embodiment, the invention provides a method of providing a system for tagging an entity in a virtual universe. In this case, a computer system, such as administrator 16 (FIG. 1), can be generated (e.g., created, deployed, maintained, having made available to, supported etc.) and one or more programs/systems, e.g., fraudulence preventing system 38 (FIG. 1), for performing the process described herein can be obtained (e.g., created, purchased, used, modified, etc.) and deployed to the computer system. To this extent, the deployment can comprise one or more of: (1) installing program code on a computing device, such as administration center 16 (FIG. 1), from a computer-readable medium; (2) adding one or more computing devices to the computer system; and (3) incorporating and/or modifying one or more existing devices of the computer system, to enable the computer system to perform the process described herein.

It should be appreciated that the teachings of the present invention could be offered as a business method on a subscription or fee basis. For example, a fraudulence preventing system 38 (FIG. 1), and a computing device comprising fraudulence preventing system 38 (FIG. 1) could be created, maintained and/or deployed by a service provider that offers the functions described herein for customers. That is, a service provider could offer to provide a service to conduct a marketing activity as described above.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for tagging a virtual entity in a virtual universe, comprising:
providing a mechanism for a user of the virtual universe to report a conduct of the virtual entity;
receiving the report from the user; and
tagging the virtual entity based on the report in a public manner in the virtual universe.

2. The method of claim 1, further comprising providing a message of the tagging to at least one of: an owner of the virtual entity, another user of the virtual universe, or an administrator of the virtual universe in response to tagging the virtual entity as fraudulent.

3. The method according to claim 1, wherein the tagging includes associating at least one of: a visual alert or an audible alert with the virtual entity.

4. The method of claim 1, wherein the providing includes providing a user interface to the user which enables a command to implement the reporting.

5. The method of claim 1, wherein the tagging includes:
determining whether the report reliably represents the virtual entity; and
tagging the entity according to the report in response to determining the report as reliable.

6. The method according to claim 5, wherein the determining includes determining whether a preset threshold is satisfied by the report to reliably represent the virtual entity.

7. The method of claim 1, wherein at least one of the receiving or the tagging includes associating a universally unique identification of the virtual entity with information related to the reporting.

8. The method of claim 1, wherein the tagging includes:
determining whether the report meets a predetermined criteria;
responsive to the report meeting the criteria, retrieving a rule associated with the criteria; and
applying the rule to tag the virtual entity.

9. A system for tagging a virtual entity in a virtual universe, comprising:
system for providing a mechanism for a user of the virtual universe to report a conduct of the virtual entity;
system for receiving the report from the user; and
system for tagging the virtual entity based on the report in a public manner in the virtual universe.

10. The system of claim 9, further comprising system for providing a message of the tagging to at least one of: an owner of the virtual entity, another user of the virtual universe, or an administrator of the virtual universe in response to the virtual entity being tagged as fraudulent.

11. The system according to claim 9, wherein the tagging system associates at least one of: a visual alert or an audible alert with the virtual entity.

12. The system of claim 9, wherein the providing system provides a user interface to the user which enables a command to implement the reporting.

13. The system of claim 9, wherein the tagging system includes system for determining whether the report reliably represents the virtual entity, and tags the entity according to the report in response to the report being determined as reliable.

14. The system according to claim 13, wherein the determining system determines whether a preset threshold is satisfied by the report to reliably represent the virtual entity.

15. The system of claim 9, wherein at least one of the receiving system or the tagging system associates a universally unique identification of the virtual entity with information related to the reporting.

16. The system of claim 9, wherein the tagging means:
determines whether the report meets a predetermined criteria;
responsive to the report meeting the criteria, retrieves a rule associated with the criteria; and
applies the rule to tag the virtual entity.

17. A computer program product embodied in a computer readable medium comprising:
computer usable program code which, when executed by a computer system, enables the computer system to:
provide a mechanism for a user of the virtual universe to report a conduct of the virtual entity;
receive the report from the user; and
tag the virtual entity based on the report in a public manner in the virtual universe.

18. The program product of claim 17, wherein the program code is further configured to enable the computer system to provide a message of the tagging to at least one of: an owner of the virtual entity, another user of the virtual universe, or an administrator of the virtual universe in response to tagging the virtual entity as fraudulent.

19. The program product of claim 17, wherein the program code is configured to enable the computer system to associate at least one of: a visual alert or an audible alert with the virtual entity.

20. The program product of claim 17, wherein the program code is configured to enable the computer system to provide a user interface to the user which enables a command to implement the reporting.

21. The program product of claim 17, wherein the program code is configured to enable the computer system to:
determine whether the report reliably represents the virtual entity; and
tag the entity according to the report in response to determining the report as reliable.

22. The program product of claim 17, wherein the program code is further configured to enable the computer system to determine whether a preset threshold is satisfied by the report to reliably represent the virtual entity.

23. The program product of claim 17, wherein the program code is further configured to enable the computer system to associate a universally unique identification of the virtual entity with information related to the reporting.

24. The program product of claim 17, wherein program code is further configured to enable the computer system to:
determine whether the report meets a predetermined criteria;
responsive to the report meeting the criteria, retrieve a rule associated with the criteria; and
apply the rule to tag the virtual entity.

25. A method for providing a system for tagging a virtual entity in a virtual universe, comprising:
at least one of: creating, maintaining, deploying or supporting a computer infrastructure being operable to:
provide a mechanism for a user of the virtual universe to report a conduct of the virtual entity;
receive the report from the user; and
tag the virtual entity based on the report in a public manner in the virtual universe.
